(19) United States
(12) Patent Application Publication
(10) Pub. No.: US 2014/0297921 A1
(43) Pub. Date: Oct. 2, 2014

(54) Method of Partitioning Physical Block and Memory System Thereof

(71) Applicant: SKYMEDI CORPORATION, Hsinchu City (TW)

(72) Inventor: Yu-Tang Chang, Hsinchu City (TW)

(73) Assignee: SKYMEDI CORPORATION, Hsinchu City (TW)

(21) Appl. No.: 13/850,310

(22) Filed: Mar. 26, 2013

(51) Int. Cl. G06F 3/06; G06F 12/02

(52) U.S. Cl. CPC G06F 3/0644; G06F 12/0246
USPC 711/103; 711/153

(57) ABSTRACT

A method of partitioning a physical block in a memory includes: determining a sub-block size according to a data length of a sequential write and a block size; partitioning the physical block into sub-blocks, each having a size equal to the sub-block size; and mapping logical blocks to the sub-blocks.

### BACKGROUND OF THE INVENTION

1. Field of the Invention

The present invention relates to a method of partitioning a physical block in a memory system and the memory system thereof, and more particularly, to a method of partitioning a physical block into sub-blocks in a memory according to a data length of a sequential write and a block size of the memory and the memory system thereof.

2. Description of the Prior Art

A memory controller is commonly utilized for task management in a memory system, especially in a non-volatile memory system. In general, since data stored in a non-volatile memory system may not be lost after electric power of the non-volatile memory system is cut off, the non-volatile memory system becomes an important means to store system data. Among those non-volatile memory systems, NAND flash memory, which has advantages of low power and high speed, becomes popular with the popularization of portable devices in recent years.

In the NAND flash memory, read/write operation is performed based on a unit of page, and erasing operation is performed based on a unit of block, where a block size is usually far greater than a page size. In general, a block may be composed of 64 or 128 pages. When a user needs to access data in the NAND flash memory, the corresponding data address should be mapped from the logical block to the physical block. There are two commonly used methods for this mapping: page mapping and block mapping. According to the page mapping method, the data address is mapped from the logical page to the physical page. In other words, when a page of new data needs to be written in the memory, an empty physical page is found and this new data is written in the physical page. A mapping table then records the address of the physical page corresponding to the logical page. When the page mapping method is applied, however, the mapping table becomes very large, and a large random access memory (RAM) should be utilized for storing the mapping table.

In order to reduce the RAM size, the block mapping method can be applied. According to the block mapping method, the data address is mapped from the logical block to the physical block, such that the mapping table only needs to record the address of the physical block corresponding to each logical block. As mentioned above, a block size is far greater than a page size, which means that the number of blocks is far less than the number of pages in a memory system, such that the size of the mapping table can be reduced. According to the block mapping method, when a page of new data needs to be written in one page in a first block, a second block is selected and this page of data is written in the corresponding physical page in the second block. In addition, data in other pages in the first block should be copied back to the corresponding pages in the second block. For example, please refer to FIG. 1, which is a schematic diagram of a memory system 10 where a new page of data is written according to the block mapping scheme. As shown in FIG. 1, the memory system 10 includes 4 logical blocks with logical block addresses (LBA) L0-L3 and 4 physical blocks with physical block addresses (PBA) P0-P3. Assume that data in the logical block L0 corresponds to that in the physical block P1 originally. When a page of new data N1 is written in the logical block L0 in the memory system 10, the data N1 cannot be written in the corresponding page in the physical block P1 directly. Instead, the write should be performed through all pages in a physical block. Firstly, another physical block (e.g. P2) is selected, and new arriving data and original data should be written in all pages in the physical block P2 in a predefined order. In detail, data P1A is copied from the physical block P1 to the corresponding pages in the physical block P2, and then the new data N1 is written in the physical block P2. Following the new data N1, data P1B is copied from the physical block P1 to the physical block P2. Finally, in the mapping table, the logical block L0 is mapped to the physical block P2 instead of P1, in order to accomplish the writing process.

As illustrated above, even if there is only one page of data having to be written in the memory system 10, the write should be performed in the whole physical block, which reduces efficiency considerably. Therefore, the industry has developed a hybrid mapping method combining block mapping and page mapping. The hybrid mapping method divides the physical block into a page mapping part and a block mapping part. When a random write with only a few pages of data arrives, the data can be assigned to the page mapping part; when a sequential write with longer data arrives, the data can be assigned to the block mapping part. In the block mapping part, if the data length of sequential write is different from the block size, there is still several old data in the original block having to be copied to the target block, and such operation is called copy back and will reduce the efficiency of data access. Especially in recent years, the size of a memory system is expanded increasingly, such that the block size is also expanded. In such a condition, copy back may need to be performed in more pages in each block, which reduces the efficiency much more. Thus, there is a need for improvement over the prior art.

### SUMMARY OF THE INVENTION

It is therefore an objective of the present invention to provide a method of partitioning a physical block into sub-blocks in a memory according to a data length of a sequential write and a block size of the memory and the memory system thereof.

The present invention discloses a method of partitioning a physical block in a memory. The method comprises determining a sub-block size according to a data length of a sequential write and a block size; partitioning the physical block into sub-blocks, each having a size equal to the sub-block size; and mapping logical blocks to the sub-blocks.

The present invention further discloses a memory system. The memory system comprises a memory; and a memory controller, embodied a program executed by a processor to perform a method of partitioning a physical block in the memory. The method comprises determining a sub-block size according to a data length of a sequential write and a block size; partitioning the physical block into sub-blocks, each having a size equal to the sub-block size; and mapping logical blocks to the sub-blocks.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a memory system where a new page of data is written according to block mapping scheme.

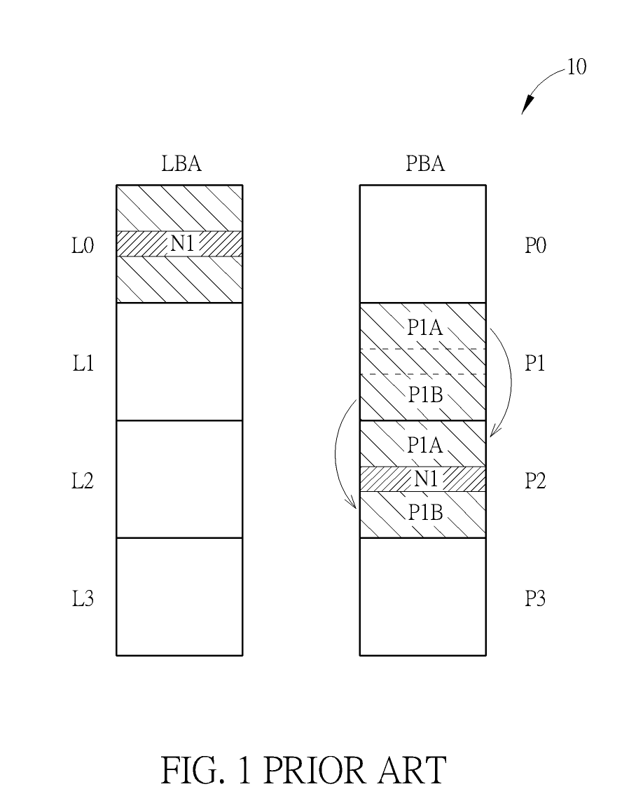

FIG. 2 is a schematic diagram of a memory system with a sequential write having data length equal to a block size according to an embodiment of the present invention.

FIG. 3 is a schematic diagram of a memory system with a sequential write having data length different from a block size according to an embodiment of the present invention.

FIG. 4 is a schematic diagram of physical blocks in a memory system with a succession of sequential writes arriving according to an embodiment of the present invention.

FIG. 5 is a schematic diagram of another memory system with a sequential write having data length different from a block size according to an embodiment of the present invention.

FIG. 6 is a schematic diagram of a physical block in another memory system with a succession of sequential writes arriving according to an embodiment of the present invention.

### DETAILED DESCRIPTION

As mentioned above, a hybrid mapping method including both page mapping and block mapping may be applied in order to adapt to random write and sequential write simultaneously. According to block mapping, data should be written in all pages in the block, no matter whether there is a block of arriving data. If the size of arriving data is only equal to a few pages and less than a block, the other pages should be copied from corresponding pages in the original block. Performing copy back on pages with larger size reaches lower efficiency of sequential write.

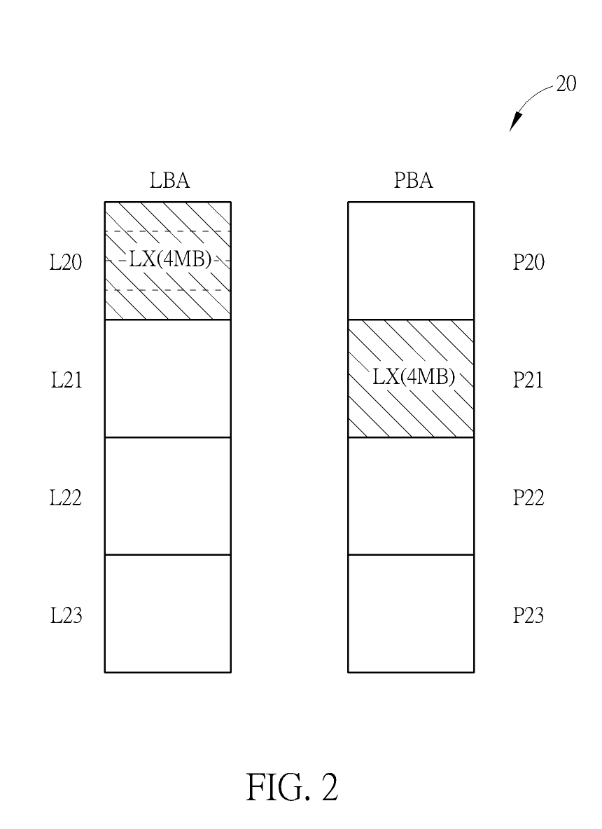

Please refer to FIG. 2, which is a schematic diagram of a memory system 20 with a sequential write having data length equal to a block size according to an embodiment of the present invention. As mentioned above, when the block size is not equal to the data length of sequential write, there will be several pages in which copy back is required to be performed; that is, several old data in the original block has to be copied to the target block. When the block size is equal to the data length of sequential write, there is no page in which copy back is required to be perform and the efficiency will be maximized. As shown in FIG. 2, the memory system 20 also includes 4 logical blocks with logical block addresses (LBA) L20-L23 and 4 physical blocks with physical block addresses (PBA) P20-P23. Assuming that a sequential write data LX with data length equal to 4 MB arrives, the sequential write data LX is stored in the logical block L20. In such a condition, since the block size is also equal to 4 MB, the logical block L20 can be mapped to the physical block P21 directly.

As a result, when a succession of sequential writes arrives at the memory system 20 continuously and each of the sequential writes has a length equal to 4 MB, each sequential write can respectively be performed through all pages in one block of the memory system 20. In such a condition, there is no redundant page in which copy back is required to be performed, and the efficiency of sequential write can therefore be maximized.

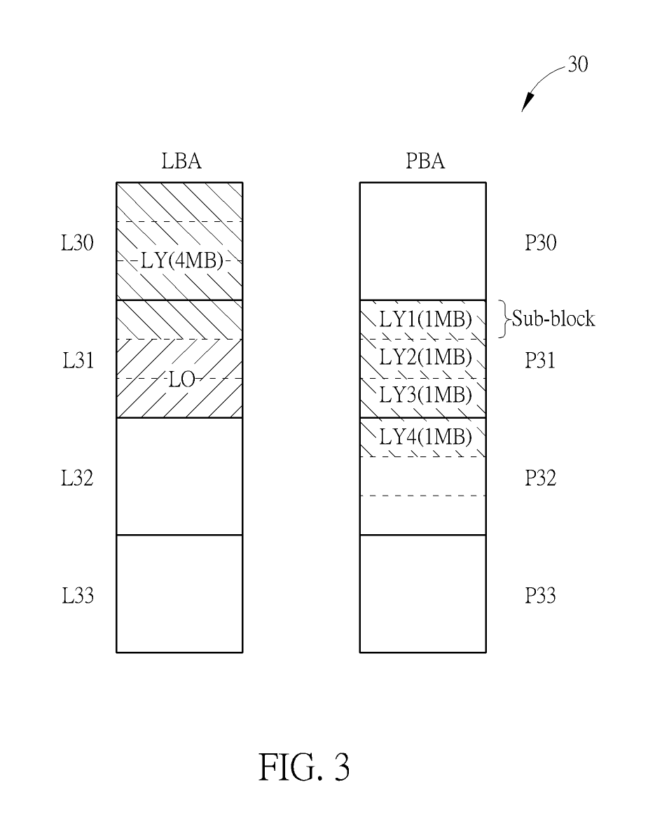

Sometimes the data length of sequential write may be different from the block size. Please refer to FIG. 3, which is a schematic diagram of a memory system 30 with a sequential write having data length different from a block size according to an embodiment of the present invention. As shown in FIG. 3, the memory system 30 includes 4 logical blocks with LBA L30-L33 and 4 physical blocks with PBA P30-P33. Different from the memory system 20, the block size of each logical block and physical block in the memory system 30 is 3 MB rather than 4 MB. When a sequential write data LY with data length equal to 4 MB arrives, one and one-third of logical blocks will be occupied by the data LY, such that one-third of an extra physical block may be utilized for storing the data LY. When the conventional block mapping is applied, two-third of the physical block should be utilized for storing the other data LO originally mapped to the logical block LBA L31. In order to avoid copy back due to the difference between the data length of sequential write and the block size, the physical block may be partitioned into sub-blocks, in order to ensure that the sequential write can be performed through all pages in each individual sub-block. As shown in FIG. 3, each physical block can be partitioned into 3 sub-blocks, and each sub-block has a size equal to 1 MB. Since the length of the data LY is equal to 4 MB, the data LY may be stored in 4 sub-blocks exactly. In detail, the data LY is partitioned into sub-data LY1-LY4 with each sub-data size equal to 1 MB. The sub-data LY1-LY4 can be stored in different sub-blocks respectively. In such a condition, the logical blocks can be mapped to the sub-blocks, and each of the entire sub-blocks is used for storing sub-data. There is no redundant page in which copy back is required to be performed. As a result, the efficiency of sequential write can thereby be maximized.

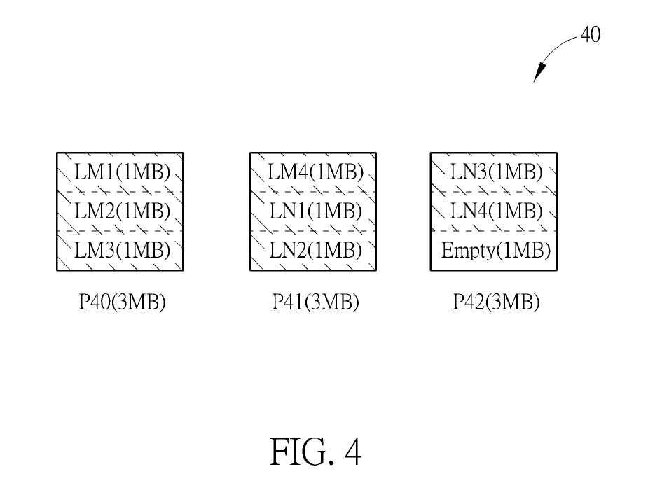

Please refer of FIG. 4, which is a schematic diagram of physical blocks P40-P42 in a memory system 40 with a succession of sequential writes arriving according to an embodiment of the present invention. As shown in FIG. 4, when the succession of sequential writes with data LM and LN having a data length equal to 4 MB arrives at the memory system 40, and the block size in the memory system 40 is equal to 3 MB, the data LM and LN can be partitioned into 4 sub-data LM1-LM4 and LN1-LN4, respectively, and each sub-data has a data length equal to 1 MB. Each of the physical blocks P40-P42 can be partitioned into 3 sub-blocks, and each sub-block has a block size equal to 1 MB. The sub-blocks can be utilized for storing each of the sub-data LM1-LM4 and LN1-LN4. Therefore, the logical blocks can be mapped to the sub-blocks, and there is no redundant page in which copy back is required to be performed.

In most cases, the physical blocks are partitioned into sub-blocks in order to prevent several pages in the physical blocks from storing the other data due to copy back. Therefore, the sub-block size may be determined according to the data length of sequential write and the block size. More specifically, the sub-block size can be set as a highest common factor of the data length of sequential write and the block size. As shown in FIG. 3, the data length of sequential write is 4 MB and the block size is 3 MB, and the sub-block size can be obtained by calculating the highest common factor of the data length of sequential write (4 MB) and the block size (3 MB); that is, the sub-block size will be 1 MB.

In general, the block size is equal to a number of units where the number is a power of two, where the unit may be a smallest programming unit in the memory. For example, when the unit is MB and the block size is equal to a specific number of MB, e.g. 1 MB, 2 MB or 4 MB, the data of sequential write (4 MB) may occupy one or more whole logical blocks exactly. Each of the logic blocks can be mapped to a physical block, respectively, and the data of sequential write can be stored in the whole physical block. Therefore, there is no page in which copy back is required to be performed. On the other hand, if the number is not a power of two, e.g. the block size is equal to 3 MB or 5 MB, the data of sequential write (4 MB) may not occupy whole logical blocks. In such a condition, the physical block should be partitioned into sub-blocks.

Please note that, as long as there is no page in which copy back is required to be performed such that no other data is stored, the partitioning can be performed in any manners. If the sub-block size is smaller, it is more probable that there is no page in which copy back is required to be performed, but more random access memory (RAM) will be required for storing the mapping table. According to the above embodiment, when the sub-block size is set as the highest common factor of the data length of sequential write and the block size, the block mapping without copy back can be achieved and the RAM required for storing the mapping table can be minimized.

In some embodiments, even if the block size is equal to a number of units where the number is a power of two, the data of sequential write (4 MB) may not occupy a whole logical block or several whole logical blocks exactly. Such a block size may be 8 MB, 16 MB, etc. In such a condition, a sequential write data only occupies partial of a logical block, and when the logical block is mapped to the physical block, there will still be several pages in the physical block that copy back has to be performed, which reduces the efficiency of data access. Therefore, the physical block should also be partitioned, in order to avoid the copy back.

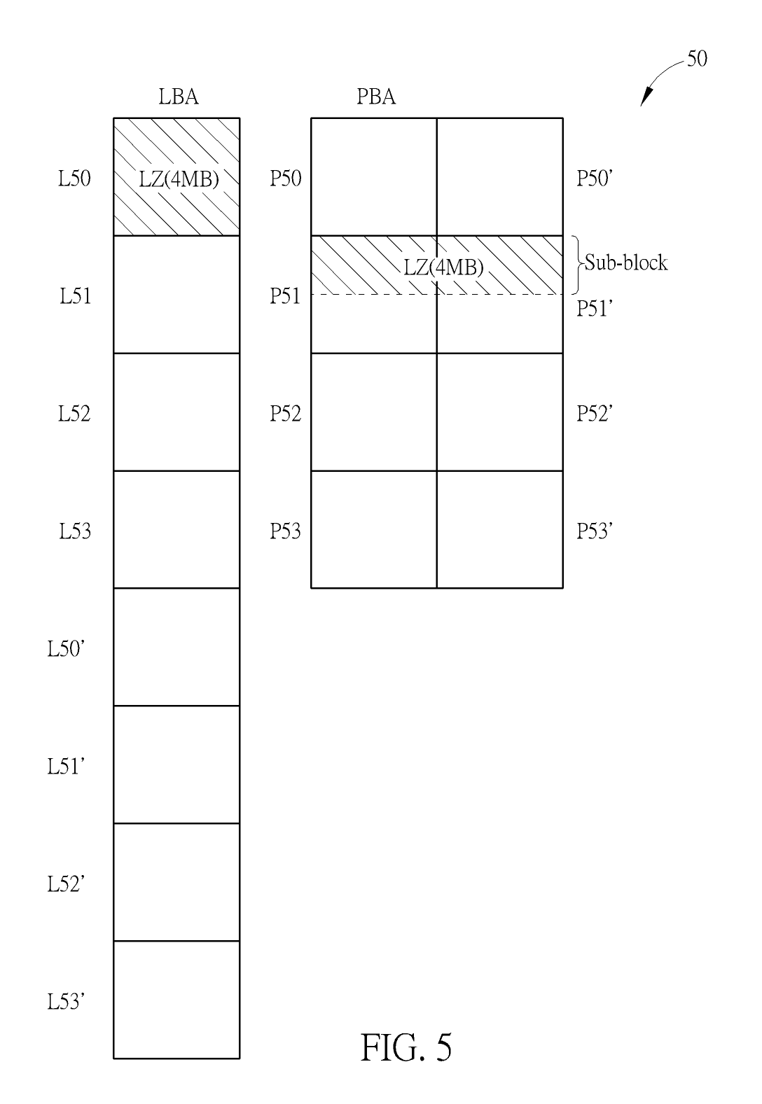

Please refer to FIG. 5, which is a schematic diagram of another memory system 50 with a sequential write having data length different from a block size according to an embodiment of the present invention. As shown in FIG. 5, the memory in the memory system 50 is composed of two sub-memories, where one sub-memory has 4 logical blocks with LBA L50-L53 and the other has 4 logical blocks with LBA L50′-L53′. Corresponding physical blocks with PBA P50-P53 and P50′-P53′ are also included in the memory system 50. All of the logical blocks and the physical blocks in both sub-memories have a block size equal to 4 MB. Since each physical block in the memory system 50 is composed of two physical blocks in the sub-memories, the physical block in the memory system 50 has a block size equal to 8 MB. In detail, each physical block P50-P53 in the first sub-memory is combined with a corresponding physical block P50′-P53′ in the second sub-memory, and the block size becomes twice of the size of the original physical blocks; that is, 8 MB. In such a condition, when the data length of sequential write is equal to 4 MB, the data of sequential write is stored in half a physical block. In order to prevent copy back from being performed in the other half of the physical block, the physical block may be partitioned into 2 sub-blocks, and each sub-block has a block size equal to 4 MB, which is equal to the data length of sequential write. As a result, the sequential write can be performed in a whole sub-block and there is no redundant page in which copy back is required to be performed, such that the efficiency of sequential write will thereby be maximized.

Please note that, in the above embodiment, the block size is 8 MB and the data length of sequential write is 4 MB. The highest common factor of the data length of sequential write and the block size is equal to 4 MB. Therefore, the optimal partitioning method is to partition the physical block in order to make the sub-block size equal to 4 MB, such that the logical block can be mapped to the sub-block, as illustrated in FIG. 5.

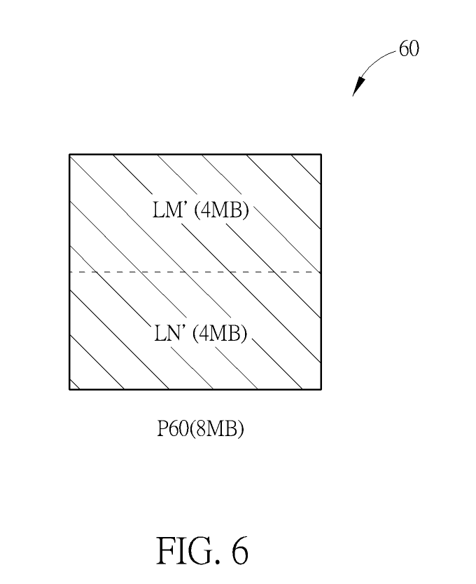

Similarly, please refer to FIG. 6, which is a schematic diagram of a physical block 60 in another memory system 60 with a succession of sequential writes arriving according to an embodiment of the present invention. As shown in FIG. 6, when the succession of sequential writes with data LM′ and LN′ having a data length equal to 4 MB arrives at the memory system 60, and the block size in the memory system 60 is equal to 8 MB, the physical block P60 can be partitioned into 2 sub-blocks, among which one sub-block stores the data LM′ and the other stores the data LN′. Therefore, the logical blocks can be mapped to the sub-blocks, and there is no redundant page in which copy back is required to be performed.

Please note that, in the memory systems 50 and 60, the physical blocks are partitioned into sub-blocks with a sub-block size equal to 4 MB; hence the sequential write with data length equal to 4 MB can be performed through all pages in a sub-block, and there is no page in which copy back is required to be performed. In order to ensure that the sequential write can be performed through a whole block to avoid copy back, these physical blocks may also be partitioned in other methods. Other feasible sub-block size may be equal to 2 MB or 1 MB. This partitioning method, however, will consume more RAM for storing mapping table than if the sub-block size is equal to 4 MB. Therefore, the optimal partitioning method is to make the sub-block size equal to the highest common factor of the data length of sequential write and the block size. On the other hand, the partitioning methods for the memory systems 20, 30, 40, 50 and 60 in the above embodiments are most suitable for the case where a succession of sequential writes with equal data length arrives. When the sequential writes with different data lengths arrive, the above partitioning methods may also be applied. In such a condition, there may unavoidably be several pages in which copy back should be performed.

Please note that, the spirit of the present invention is to provide a method of partitioning a physic block into sub-blocks in a memory according to the data length of a sequential write and the block size of the memory. Those skilled in the art can make modifications or alternations accordingly. For example, although the data length of sequential write in the above embodiments is 4 MB, it may be 2 MB, 8 MB or any other lengths. In the above embodiments, when the block size is equal to 2.5 MB or 3.5 MB, the partitioning principle of the highest common factor may not be applied if the unit of block size and data length is MB. In such a condition, the unit maybe defined as a page. For example, if the block size is equal to 3.5 MB and the page size is equal to 16 kB, a physical block will have 224 pages. When a succession of sequential writes with data length equal to 4 MB arrives where each of these sequential writes includes 256 pages, the sub-block size may be obtained by the highest common factor of 224 pages and 256 pages; that is, the sub-block size will be 32 pages or 0.5 MB.

The above embodiments are useful in a memory system with the block mapping scheme applied, where the block size can be partitioned according to the block size and the data length of sequential write. More specifically, the embodiments of the present invention can be utilized in a non-volatile memory. The non-volatile memory includes NAND flash memory or other memories in which a data has to be erased before another data is written and the block size is a minimum unit of size for erasing the data. Since the block size is the minimum unit of size for erasing the data and is far greater than a page size (a minimum unit of size for read/write the data), copy back needs to be performed if the arriving data can not be written in all pages in the block, which reduces the efficiency of data access. In such a condition, the methods of partitioning the physical blocks according to the present invention are useful for avoiding copy back. In recent years, the size of a memory system is expanded increasingly, such that the block size is also expanded. If the data length of sequential write is fixed, copy back may need to be performed in more pages in each physical block. As a result, the embodiments of the present invention will become more valuable.

In the prior art, when there is only one page of data having to be written in the memory system, the write should be performed in the whole physical block, which reduces efficiency considerably. Even if the hybrid mapping is applied, when the data length of sequential write is different from the block size, there is still several old data in the original block having to be copied to the target block, such copy back will also reduce the efficiency of data access. In comparison, the present invention provides a method of partitioning the physical block in the memory system, where the physical block is partitioned into sub-blocks according to the data length of the sequential write and the original block size. As a result, the pages in which copy back is required to be performed is minimized, and the efficiency of data access will be maximized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of partitioning a physical block in a memory, the method comprising:
determining a sub-block size according to a data length of a sequential write and a block size;
partitioning the physical block into sub-blocks, each having a size equal to the sub-block size; and
mapping logical blocks to the sub-blocks.

2. The method of claim 1, wherein determining the sub-block size according to the data length of the sequential write and the block size comprises setting the sub-block size as a highest common factor of the data length of the sequential write and the block size.

3. The method of claim 1, wherein a succession of sequential writes arrives at the memory continuously, and each of the sequential writes has a length equal to the data length.

4. The method of claim 1, wherein the memory is a non-volatile memory.

5. The method of claim 4, wherein the non-volatile memory is a NAND flash memory.

6. The method of claim 1, wherein a first data has to be erased before a second data is written in the memory, and the block size is a minimum unit of size for erasing the first data in the memory.

7. The method of claim 1, wherein the memory is composed of two sub-memories, and the block size is twice of a size of an original physical block in the sub-memories.

8. The method of claim 1, wherein the block size is equal to a number of units, wherein the number is not a power of two.

9. The method of claim 8, wherein the unit is a smallest programming unit in the memory.

10. A memory system, comprising:
a memory; and
a memory controller, embodied a program executed by a processor to perform a method of partitioning a physical block in the memory, the method comprising:
determining a sub-block size according to a data length of a sequential write and a block size;
partitioning the physical block into sub-blocks, each having a size equal to the sub-block size; and
mapping logical blocks to the sub-blocks.

11. The memory system of claim 10, wherein determining the sub-block size according to the data length of the sequential write and the block size comprises setting the sub-block size as a highest common factor of the data length of the sequential write and the block size.

12. The memory system of claim 10, wherein a succession of sequential writes arrives at the memory continuously, and each of the sequential writes has a length equal to the data length.

13. The memory system of claim 10, wherein the memory is a non-volatile memory.

14. The memory system of claim 13, wherein the non-volatile memory is a NAND flash memory.

15. The memory system of claim 10, wherein a first data has to be erased before a second data is written in the memory, and the block size is a minimum unit of size for erasing the first data in the memory.

16. The memory system of claim 10, wherein the memory is composed of two sub-memories, and the block size is twice of a size of an original physical block in the sub-memories.

17. The memory system of claim 10, wherein the block size is equal to a number of units, wherein the number is not a power of two.

18. The memory system of claim 17, wherein the unit is a smallest programming unit in the memory.
